(19) United States
(12) Patent Application Publication
(10) Pub. No.: US 2026/0140704 A1
(43) Pub. Date: May 21, 2026

(54) METHOD FOR GENERATING AI AGENT USING LARGE LANGUAGE MODEL AND COMPUTING DEVICE OPERATING THE SAME

(71) Applicant: Vessl AI Korea Inc., Gwangju (KR)

(72) Inventor: Ji Hwan CHUN, Seongnam-si (KR)

(73) Assignee: Vessl AI Korea Inc., Gwangju (KR)

(21) Appl. No.: 19/271,933

(22) Filed: Jul. 17, 2025

(30) Foreign Application Priority Data
Nov. 21, 2024 (KR) 10-2024-0166872

(51) Int. Cl. G06F 8/30; G06F 8/41

(52) U.S. Cl. CPC G06F 8/30; G06F 8/433

(57) ABSTRACT

Disclosed is an AI agent generation method using a large language model, which is performed by a processor. The method includes receiving a request message from a user device, generating a pseudo-code, which has a predefined schema and a predetermined data form, by using the large language model, in response to the request message thus received, verifying the schema of the pseudo-code thus generated, verifying validity of the pseudo-code thus generated, generating an executable code based on the pseudo-code thus verified, and executing the executable code.

### CROSS-REFERENCE TO RELATED APPLICATIONS

This application claims priority under 35 U.S.C. § 119 to Korean Patent Application No. 10-2024-0166872 filed on Nov. 21, 2024, in the Korean Intellectual Property Office, the disclosures of which are incorporated by reference herein in their entireties.

### BACKGROUND

Embodiments of the present disclosure described herein relate to a method of generating an AI agent using a large language model and a computing device performing the same, and more particularly, relate to an AI agent generating method reducing uncertainty of a large language model and accurately generating a workflow which a user wants and a computing device performing the same.

With the recent development of artificial intelligence technologies, a large language model (LLM) is being used in various fields. In particular, the field of generative artificial intelligence (AI) is rapidly growing based on the strong text generation ability of the large language model.

As one of core technologies of the generative AI, a large language model such as the GPT (Generative Pre-trained Transformer) series is trained based on vast amounts of text data and thus excels in natural language comprehension and generation. As the model is applied to various applications such as text generation, translation, summary, and question and answer (Q&A), the model is showing remarkable performance.

Despite the characteristics and advantages of the large language model, several limitations exist when the large language model is utilized as an agent to perform a specific task. Accordingly, a method to overcome the limitations is being required.

The background art is provided to facilitate better understanding of the present disclosure. It should not be construed that the matters described in the background art are acknowledged as existing in the prior art.

Nowadays, the development of AI agent using the large language model is the center of attention in the field of artificial intelligence. The large language model predicts the next word with the highest possibility in association with a given input and generates a text based on the prediction. An executable code of the agent may be directly generated in the probability-based generation manner, but the manner which allows the LLM to directly generate the executable code causes various issues.

Firstly, the large language model may generate different outputs whenever the same input is provided thereto, making it difficult to predict or control a result and to obtain a perfect result with one attempt.

Secondly, the large language model tends to output non-existent information or non-executable code as a result of execution.

Thirdly, for the above reasons, because it is difficult to trust and execute the code generated by the large language model, the operation of the AI agent may be unstable, or unexpected results may be caused.

Fourthly, the output may be controlled by fixing a random seed such that the large language model generates a stable and uniform execution result, which degrades the generative power of the large language model. This may mean that the large language model fails to generate various responses.

Accordingly, the inventors of the present disclosure have developed an AI agent generation method which accurately generates a safe, predictable, and user-desired workflow by reducing uncertainty while maintaining generative flexibility of a large language model, and a computing device performing the same.

Therefore, an object of embodiments is directed to provide an AI agent generation method using a large language model and a computing device performing the same.

Problems to be solved by the present disclosure are not limited to the above problems, and other problems not mentioned herein may be clearly understood from the specification and the accompanying drawings by one skilled in the art to which the present disclosure pertains.

### SUMMARY

According to an embodiment, an AI agent generation method using a large language model, which is performed by a processor, may include receiving a request message from a user device, generating a pseudo-code, which has a predefined schema and a predetermined data form, by using the large language model, in response to the request message thus received, verifying the schema of the pseudo-code thus generated, verifying validity of the pseudo-code thus generated, generating an executable code based on the pseudo-code thus verified, and executing the executable code. The verifying of the schema of the pseudo-code thus generated includes determining whether a steps field or a dependencies field is included in the pseudo-code, determining whether a first step field included in the steps field includes a compulsory field, and determining whether a type of a type field included in the first step field is one of predefined types.

According to an aspect of the present disclosure, the predetermined data form may be a YAML (YAML Ain't Markup Language) form.

According to an embodiment of the present disclosure, the verifying of the validity of the pseudo-code thus generated may include determining whether a tool of a tool field included in the first step field is one of predefined tools, and determining whether a cycle exists between step fields included in the steps field based on the dependencies field.

According to another aspect of the present disclosure, the method may further include regenerating the pseudo-code, when the verifying of the schema or the verifying of the validity is failed, and the regenerating of the pseudo-code may be repeated up to N times (N being a positive integer).

According to another aspect of the present disclosure, the generating of the executable code based on the pseudo-code thus verified may include mapping a step corresponding to at least one step field included in the pseudo-code in the form of a predetermined object, and the executable code may be a static code.

According to another aspect of the present disclosure, the method may further include transferring a result of executing the executable code to the user device.

According to an embodiment, a computing device for an operation of an AI agent may include a memory, a transceiver that receives a request message from a user device, and at least one processor that includes a large language model (LLM). The processor may generate a pseudo-code, which has a predefined schema and a predetermined data form, by using the large language model, in response to the request message thus received, may verify the schema of the pseudo-code thus generated, may verify validity of the pseudo-code thus generated, may generate an executable code based on the pseudo-code thus verified, and may execute the executable code. In the verifying of the schema of the pseudo-code thus generated, the processor may determine whether a steps field of a dependencies field is included in the pseudo-code, may determine whether a first step field included in the steps field includes a compulsory field, and may determine whether a type of a type field included in the first step field is one of predefined types.

A computer program according to an embodiment may be a computer program that is stored in a computer-readable recording medium coupled to a computer being hardware and performs the AI agent generation method using the large language model described above.

According to an embodiment, a non-transitory computer-readable recording medium may store a computer program for executing an AI agent generation method. The method comprises receiving a request message from a user device, generating a pseudo-code, which has a predefined schema and a predetermined data form, by using a large language model, in response to the request message thus received, verifying the schema of the pseudo-code thus generated, verifying validity of the pseudo-code thus generated, generating an executable code based on the pseudo-code thus verified, and executing the executable code. The verifying of the schema of the pseudo-code thus generated may include determining whether a steps field or a dependencies field is included in the pseudo-code, determining whether a first step field included in the steps field includes a compulsory field, and determining whether a type of a type field included in the first step field is to one of predefined types.

Technical solutions of the present disclosure are not limited to the above-described solutions, and solutions that are not mentioned will be clearly understood by those skilled in the art to which the present disclosure pertains from the present specification and the accompanying drawings.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings.

FIG. 1 is a conceptual diagram illustrating an AI agent generation system using a large language model according to an embodiment of the present disclosure.

FIG. 2 is a block diagram illustrating a configuration of a computing device for an operation of an AI agent, according to an embodiment of the present disclosure.

FIG. 3 is an example diagram for describing a process for generation and operation of an AI agent, according to an embodiment of the present disclosure.

FIG. 4 is a diagram illustrating an example of pseudo-code generated by a large language model of FIG. 3.

FIGS. 5 to 7 are example diagrams for explaining an executable code generation process of a static code generator of FIG. 3.

FIG. 8 is a flowchart indicating an AI agent generation method using a large language model, which is performed by a processor, according to an embodiment of the present disclosure.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when an element is referred to as being “directly connected” or “directly coupled” to another element, it should be understood that any other element is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, and parts or a combination thereof exists, but do not preclude the presence or addition of one or more other features, numbers, steps, operations, components, and parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

For clarity of interpretation of the specification, the terms used herein will be defined below.

The term used in the specification, “large language model (LLM)”, refers to a language model capable of performing a natural language processing (NLP) task. In detail, the large language model may be a model capable of training question data including a predefined keyword to output new question data similar to question data. For example, the large language model of the present disclosure may take a query message or a request message of the user as input and output a pseudo code. In addition, the large language model may be fine-tuned according to a type of the request message of the user.

The term used in the specification, “AI agent”, refers to a software system which calls an external application programming interface (API) or an external service to automate business tasks. In detail, the AI agent may include a model, a tool, and/or a memory. As a component of the AI agent, the model may be a large language model which actually generates a text or a command. As a component of the AI agent, the tool may be a set of an API or services that can be connected to the model to perform various functions such as database inquiry, word processing, and/or customer query response. As a component of the AI agent, the memory stores a history or state in which the model uses the tool and/or a history or state in which the model generates an answer..

The term used in the specification, “pseudo-code”, refers to a code form which is defined to be easily read by a person to explain an algorithm or logic without following the grammar of an actual programming language.

The term used in the specification, “executable code”, refers to a program which is implemented with instructions actually executable by a computer through interpretation or compiling. For example, a code written in languages such as Python, JavaScript, C++, and Java may be the executable code.

The term used in the specification, “processor”, may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

In other words, the processor may refer to hardware for carrying out the technical idea of the present disclosure, software for driving the hardware, a functional combination of the hardware and the software, and/or a structural combination of the hardware and the software.

Below, embodiments will be described in detail with reference to the accompanying drawings. However, the scope of the patent application is neither limited nor restricted by the embodiments. The same reference numerals/signs in the drawings denote the same members.

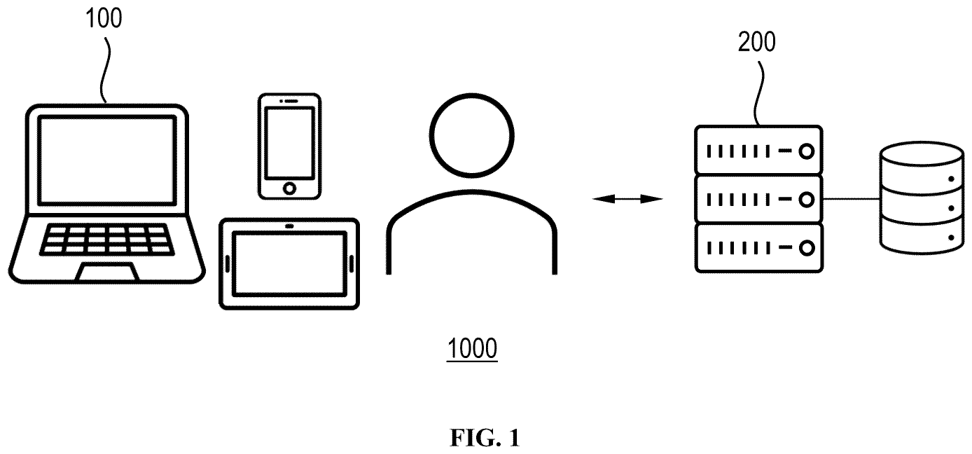

FIG. 1 is a conceptual diagram illustrating an AI agent generation system using a large language model according to an embodiment of the present disclosure.

Referring to FIG. 1, an AI agent generation system 1000 using a large language model according to an embodiment of the present disclosure may include a user device 100 and/or a computing device 200 for an operation of an AI agent. As an example, the AI agent generation system 1000 may be a system which creating or developing an AI agent depending on a request of the user, and the AI agent may generate a simple text by using the large language model and may also call an external API or service to automate the business task.

The user device 100 refers to a device of the user, which intends to transfer a query message or a request message for a specific task to the large language model or the AI agent. The user device 100 may include a smartphone, a tablet personal computer (PC), a notebook, a PC, etc. The user device 100 may install or execute at least one or more of a web, a mobile application, and a program which the computing device 200 for an operation of the AI agent provides. For example, the user device 100 may connect to a web page and may output a user interface screen capable of writing the request message in which various components are included. In the specification, the request message may be referred to as a “query message”, a “request”, a “query”, a “message”, etc. In the specification, the request message may be one of business processes. For example, the request message may be database inquiry, word processing, or a customer query response. For example, the request may be a text corresponding to content such as “Please make a chatbot answering a user's question based on web search”.

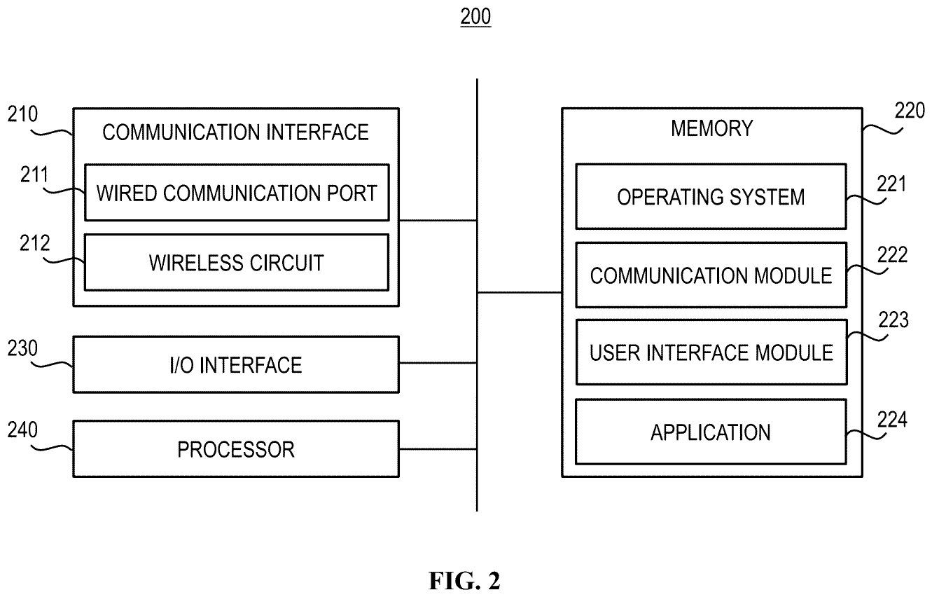

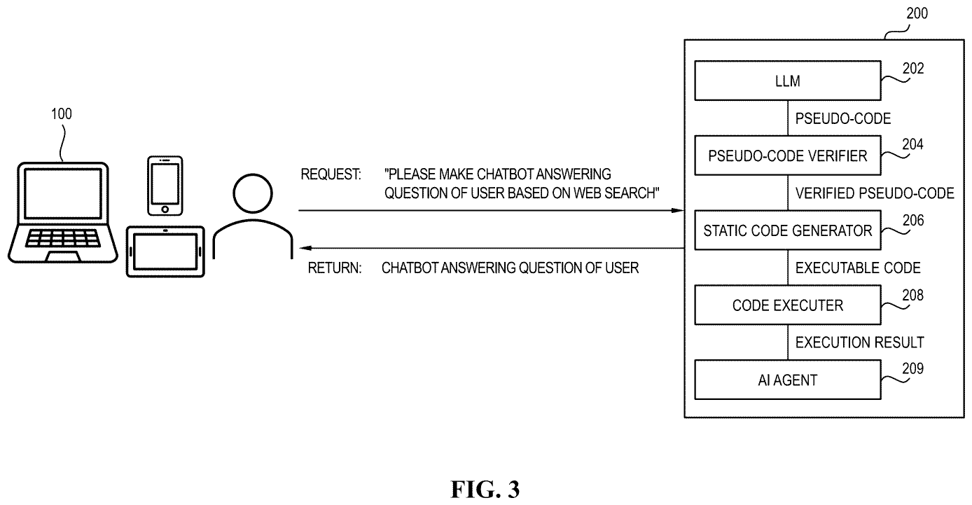

The computing device 200 for the operation of the AI agent may be a server of a service provider which provides an AI agent service performing a specific task by using the large language model. The computing device 200 may include a general purpose computer, a laptop, a data server, etc. The computing device 200 for the operation of the AI agent may provide one or more of the web, the mobile application, and the program to the user device 100 such that the AI agent service including a specific business process is capable of being provided. The computing device 200 for the operation of the AI agent will be described in detail with reference to FIGS. 2 and 3.

The AI agent generation system 1000 using the large language model according to an embodiment of the present disclosure is described above.

According to embodiments of the present disclosure, the safety of the executable code may be secured by verifying the schema and validity of the pseudo-code which the large language model generates and generating a static code. In this way, an unexpected operation or a security issue which occurs during the execution of the executable code may be prevented.

According to embodiments of the present disclosure, because only a statically defined component is used in the process of generating a code, consistent outputs may be guaranteed in association with the same input. In this case, predictability of operation of the AI agent may increase, and thus, the reliability of operation of the AI agent may be improved.

According to embodiments of the present disclosure, various workflows may be implemented by utilizing the strong text generation ability of the large language model, and thus, an AI agent capable of flexibly coping with user requirements may be implemented.

According to embodiments of the present disclosure, an error in the code generation process may be minimized through the process of verifying errors in the pseudo-code and regenerating the pseudo-code. Also, an execution speed may be improved through the generation of the static code, and resources may be optimally used.

According to embodiments of the present disclosure, because functions of the system are expanded by adding a new step type or a tool to the schema, a general-purpose AI agent applicable to various application fields may be created (or developed).

FIG. 2 is a block diagram illustrating a configuration of a computing device for an operation of an AI agent, according to an embodiment of the present disclosure.

Referring to FIG. 2, the computing device 200 for the operation of the AI agent may be a server which provides an AI agent service depending on a request of the user or the user device 100 or a computing device on which one or more of a web page, an application, and a program that can perform a specific business process are installed and executed.

The computing device 200 for the operation of the AI agent may include a communication interface 210, a memory 220, an input/output (I/O) interface 230, and/or a processor 240, which communicate with each other through one or more communication buses or signal lines.

The communication interface 210 may be connected to the user device 100 over a wired/wireless communication network to exchange data. For example, when the computing device 200 for the operation of the AI agent is a server, the communication interface 210 may receive the request message from the user device 100.

Meanwhile, the communication interface 210 which enables the transmission/reception of data may include a wired communication port 211 and a wireless circuit 212. Herein, the wired communication port 211 may include one or more wired interfaces, for example, Ethernet, universal serial bus (USB), IEEE1394 (e.g., FireWire of Apple, i.Link of Sonny, or Lynx of Texas Instrument), etc. Also, the wireless circuit 212 may transmit/receive data to/from an external device through a radio frequency (RF) signal or an optical signal. Furthermore, the wireless communication may use at least one of a plurality of communication standards, protocols, and technologies, for example, global system for mobile communications (GSM), enhanced data rates for GSM evolution (EDGE), code-division multiple access (CDMA), time division multiple access (TDMA), Bluetooth, Wi-Fi, VoIP, Wi-MAX, and any other appropriate communication protocol.

The memory 220 may store a variety of data which are used in the computing device 200 for the operation of the AI agent. For example, the memory 220 may store the large language model. For another example, the memory 220 may store information necessary to train the large language model according to an embodiment of the present disclosure and to infer a result. Also, the memory 220 may store a history or state in which the large language model uses a tool and/or a history or state in which the model generates an answer.

In various embodiments, the memory 220 may include a volatile or nonvolatile recording medium capable of storing various kinds of data, commands, and/or information. For example, the memory 220 may include a storage medium of at least one type of the following types: a flash memory type, a hard disk type, a multimedia card micro type, a card type memory (e.g., an SD or XD memory), a random access memory (RAM), a static RAM (SRAM), a read-only memory (ROM), a programmable ROM (PROM), an electrically erasable programmable ROM (EEPROM), network storage, cloud, and a blockchain database.

In various embodiments, the memory 220 may store at least one of an operating system 221, a communication module 222, a user interface module 123, and one or more applications 224.

The operating system 221 (e.g., an embedded operating system such as LINUX, UNIX, MAC OS, WINDOWS, or VxWorks) may include various software components and drivers for controlling and managing general system tasks (e.g., memory management, storage device control, and power management) and may support communication between various hardware, firmware, and software components.

The communication module 222 may support communication with any other device through the communication interface 210. The communication module 222 may include various software components for processing data received by the wired communication port 211 or the wireless circuit 212 of the communication interface 210.

The user interface module 223 may receive a request or an input of the user from a keyboard, a touchscreen, a keyboard, a mouse, and/or a microphone through the I/O interface 230 and may provide a user interface on a display.

The application 224 may include a program or a module which is configured to be executable by one or more processors 240. Herein, an application which provides an AI agent generation service for processing all processes necessary to train the large language model, to generate the pseudo-code, to generate the executable code, and/or to execute the executable code may be implemented on a server farm.

The I/O interface 230 may connect an input/output device (not illustrated) of the computing device 200 for the operation of the AI agent, for example, at least one of a display, a keyboard, a touchscreen, and a microphone with the user interface module 223. The I/O interface 230 may receive a user input (e.g., a voice input, a keyboard input, or a touch input) together with the user interface module 223 and may process a command according to the received input.

The processor 240 may be connected to the communication interface 210, the memory 220, and the I/O interface 230 to control all operations of the computing device 200 for the operation of the AI agent and may perform various commands for generation and operations of the AI agent through the application and/or the program stored in the memory 220.

The processor 240 may correspond to a computing device such as a central processing unit (CPU) or an application processor (AP). Also, the processor 140 may be implemented in the form of an integrated chip (IC) such as a system on chip (SoC) in which various computing devices are integrated. In addition, the processor 140 may include a module for calculating an artificial neural network model such as a neural processing unit (NPU).

FIG. 3 is an example diagram for describing a process for generation and operation of an AI agent, according to an embodiment of the present disclosure.

FIG. 3 shows a process in which, when the user transfers the request message to the computing device 200 for the operation of the AI agent through the user device 100, the computing device 200 for the operation of the AI agent generates an AI agent and returns a response to the request of the user to the user device 100. The computing device 200 for the operation of the AI agent illustrated in FIG. 3 is an example of the computing device 200 for the operation of the AI agent of FIGS. 1 and 2.

The computing device 200 for the operation of the AI agent may include a large language model (LLM) 202, a pseudo-code verifier 204, a static code generator 206, a code executer 208, and/or an AI agent 209. According to an embodiment, only the large language model 202 may be included in the AI agent 209, and the pseudo-code verifier 204, the static code generator 206, and/or the code executer 208 may be further included. At least some of the blocks illustrated in FIG. 3 may be implemented with hardware logic in some embodiments or may be implemented with a software module which is executed by at least one processor in some embodiments.

According to an embodiment, the user may input the request message including content “Please make a chatbot answering a user's question based on web search” by using the user interface of the user device 100. The corresponding request message may be transferred to the computing device 200 for the operation of the AI agent.

When the computing device 200 for the operation of the AI agent receives the request message from the user device 100, the large language model 202 may generate the pseudo-code.

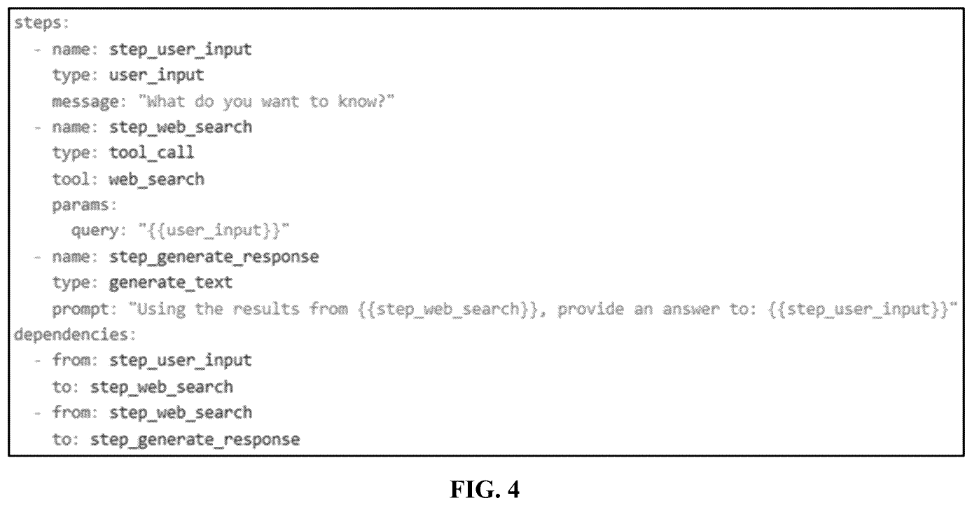

An example of the pseudo-code which the large language model 202 generates is shown in FIG. 4.

According to an example of the pseudo-code which the large language model 202 generates, the pseudo-code includes a steps field and a dependencies field. In the specification, the steps field which is a field included in the pseudo-code means a field corresponding to steps, some operations or processes necessary to generate a response according to a request of the user. The dependencies field which is a field included in the pseudo-code means a field indicating dependency between step fields.

According to an embodiment, the steps field may include three step fields, that is, a step field corresponding to a step in which the user inputs a message, a step field corresponding to a step in which web search is made, and a step field corresponding to a step in which a response is generated based on a web search result. Each step field may include various fields, which are necessary to define each step, such as a name field, a type field, a tool field, and a message field, and various fields necessary to perform each step.

According to an embodiment, the dependencies field may include two from-to fields. In detail, the dependencies field may include a from-to field indicating that the step in which the web search is made is performed after the step in which the user inputs the message, and a from-to field indicating that the step in which the response is generated based on the web search result is performed after the step in which the web search is made. Each from-to field may include from field and to field.

The large language model 202 may transfer the generated pseudo-code to the pseudo-code verifier 204. The pseudo-code verifier 204 may verify the schema and/or the validity of the pseudo-code received from the large language model 202.

According to an embodiment, the pseudo-code verifier 204 may verify the schema of the pseudo-code received from the large language model 202. In an embodiment, the pseudo-code verifier 204 may determine whether the steps field and the dependencies field exist. Then, the pseudo-code verifier 204 may determine whether a compulsory field (e.g., a name field or a type field) to be included necessarily is included in each step field included in the steps field. The pseudo-code verifier 204 may determine whether a type of the type field corresponds to one of predefined types (e.g., too_call, user_input, generate_text, calculator, and calendar_booking).

According to an embodiment, the pseudo-code verifier 204 may verify the validity of the pseudo-code received from the large language model 202. In an embodiment, the pseudo-code verifier 204 may determine whether a tool of the tool field is included in a list of allowed tools. The pseudo-code verifier 204 may determine whether a type and a value of a parameter included in the pseudo-code are appropriate.

In addition, the pseudo-code verifier 204 may check the validity of the from-to field of the dependencies field. As an example, the pseudo-code verifier 204 may determine whether a cycle is absent from a dependency graph of the dependencies field. For example, the case where a from-to field indicating that the step in which the web search is made is performed after the step in which the user inputs the message, and from-to field indicating that the step in which the user inputs the message is performed after the step in which the web search is made exist means that the cycle is present in the dependency graph. When the cycle is present in the dependency graph, the corresponding cycle may be continuously repeated, thereby making it impossible to obtain an execution result.

When an error is detected in the verification process, the pseudo-code verifier 204 may feed an error message associated with the corresponding error back to the large language model 202 to request the regeneration of the pseudo-code. The pseudo-code regeneration request may be performed plural times. As an example, the pseudo-code regeneration request of the pseudo-code verifier 204 may be performed up to three times. The maximum number of times that the pseudo-code regeneration request is capable of being performed may be implemented to be variable.

The verification process in the above pseudo-code is a process which is easier and simpler than the verification process in the generated executable code.

The pseudo-code verifier 204 may transfer the verified pseudo-code to the static code generator 206.

The static code generator 206 may generate the executable code, based on the verified pseudo-code received from the pseudo-code verifier 204. The executable code may be a static code. In this case, the step(s) included in each step field which the pseudo-code includes may be mapped in the form of an object defined in advance. As an example, each step corresponding to each step field included in the pseudo-code may be mapped to a class or a function defined in advance.

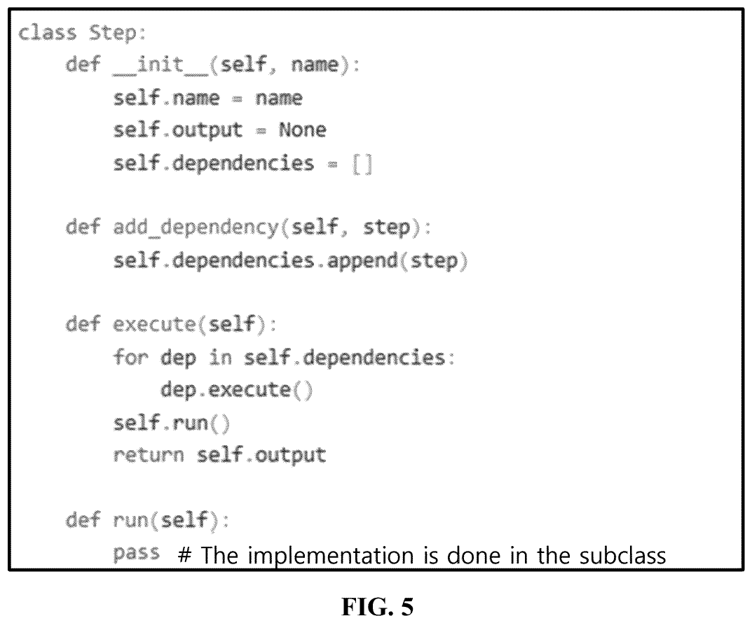

For example, when generating Pyton code, the static code generator 206 may define a base step class in a first phase, as shown in FIG. 5.

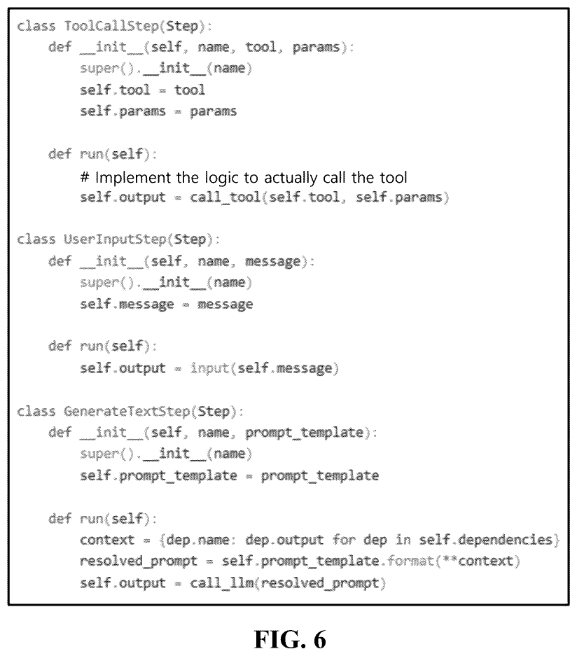

The static code generator 206 may implement a step type-specific class in a second phase, as shown in FIG. 6.

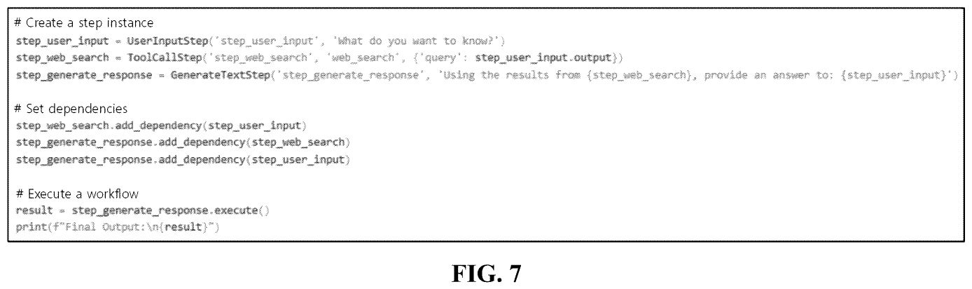

The static code generator 206 may set dependency and may execute a workflow in a third phase, as shown in FIG. 7.

The code(s) generated at the first to third phases may be a static code statically generated in a predefined form through a parameter(s) present in the verified pseudo-code received from the pseudo-code verifier 204. In other words, because the executable code is generated by the static code generator 206 to have a pre-verified form in advance, it is possible to minimize the probability that an unexpected operation or a security issue occurs when executed. Also, as the code generation workflow by the computing device 200 for the operation of the AI agent is restricted to the pseudo-code, the quality of the executable code may be guaranteed.

The static code generator 206 may transfer the generated executable code to the code executer 208.

The code executer 208 may actually execute the executable code received from the static code generator 206 and may perform an operation according to the user request.

The code executer 208 may reinforce the security of system by executing a code in a sandbox or a virtual environment. Also, the code executer 208 may guarantee a stable operation by processing an exception or an error capable of occurring during execution. A code execution result of the code executer 208 may be transferred to the user or may be utilized for a next task.

The code executer 208 may transfer the code execution result to the AI agent 209.

The AI agent 209 may return the execution result received from the code executer 208 to the user device 100 as a response to the user request. The return of the response to the user request may be performed by the chatbot answering the question of the user.

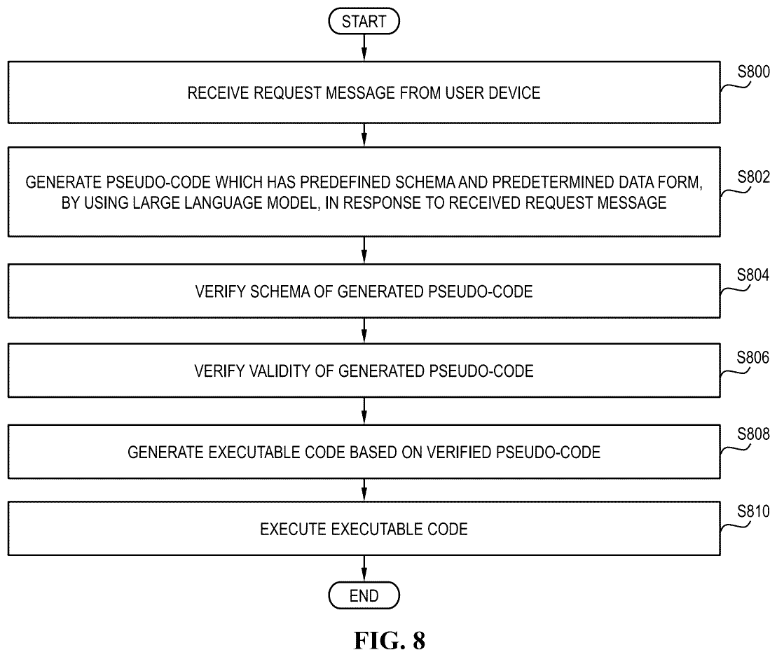

FIG. 8 is a flowchart indicating an AI agent generation method using a large language model, which is performed by a processor, according to an embodiment of the present disclosure.

According to an embodiment of the present disclosure, an AI agent generation method using a large language model may be performed by a processor.

According to the AI agent generation method using the large language model, the processor may receive the request message from the user device 100 (S800). In this case, the request message may be one of business processes. For example, the request message may be database inquiry, word processing, chatbot creating, or a customer query response.

According to the AI agent generation method using the large language model, the processor may generate the pseudo-code, which has a schema defined in advance and a data form determined in advance, by using the large language model in response to the received request message (S802).

The data form determined in advance may be a YAML (YAML Ain't Markup Language) form. However, this is provided only as an example, and the data form determined in advance may not limit the scope of the present disclosure.

According to the AI agent generation method using the large language model, the processor may verify the schema of the generated pseudo-code (S804).

The verifying of the schema of the generated pseudo-code (S804) may include determining whether a steps field or a dependencies field is included in the pseudo-code. In addition, the verifying of the schema of the generated pseudo-code (S804) may include determining whether a first step field included in steps fields includes a compulsory field. Herein, a first step corresponding to the first step field may be the step in which the user inputs a message. The compulsory field may mean a field to be included necessarily in at each step field included in the steps field. The compulsory field may include a name field, a type field, etc.

The verifying of the schema of the generated pseudo-code (S804) may include determining whether a type of a type field included in the first step field is one of types defined in advance.

According to the AI agent generation method using the large language model, the validity of the generated pseudo-code may be verified (S806).

The verifying of the validity of the generated pseudo-code (S806) may include determining whether a tool of a tool field included in the first step field is one of tools defined in advance.

The verifying of the validity of the generated pseudo-code (S806) may include determining whether a cycle exists between step fields included in the steps field based on the dependencies field.

According to the AI agent generation method using the large language model, when the processor fails in the verification of the schema or the verification of the validity, the processor may regenerate the pseudo-code. When the processor fails in the verification of the schema or the verification of the validity, the regenerating of the pseudo-code may be repeated up to N times (N being a positive integer).

According to the AI agent generation method using the large language model, the processor may generate the executable code based on the verified pseudo-code (S808).

The generating of the executable code based on the verified pseudo-code (S808) may include mapping a step corresponding to at least one step field included in the pseudo-code in the form of an object defined in advance. Herein, the executable code may be a static code.

According to the AI agent generation method using the large language model, the processor may execute the executable code (S810).

According to the AI agent generation method using the large language model, the processor transfers a result of executing the executable code to the user device 100.

According to an embodiment of the present disclosure, the computing device 200 for the operation of the AI agent may include a memory, a transceiver configured to receive the request message from the user device 100, and/or at least one processor including the large language model. The processor may be configured to generate a pseudo-code having a schema defined in advance and a data form determined in advance by using a large language model, in response to a request message received from the user device 100, to verify the schema of the generated pseudo-code, to verify the validity of the generated pseudo-code, to generate an executable code based on the verified pseudo-code, and to execute the executable code.

According to an embodiment of the present disclosure, the computing device 200 for the operation of the AI agent may include a computer program which is stored in a computer-readable recording medium coupled to a computer (or a computing device) being hardware and performing step S800 to step S810 of FIG. 8 described above.

According to an embodiment of the present disclosure, the computing device 200 for the operation of the AI agent may be implemented with a computing device including at least one processor which executes instructions of programs loaded to the memory. A program including the instructions described to execute step S800 to step S810 of FIG. 8 described above may be loaded to the memory of the computing device.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g. ; CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

According to embodiments, the safety of an executable code may be secured by verifying the schema and validity of a pseudo-code which a large language model generates and generating a static code. In this way, an unexpected operation or a security issue which occurs during the execution of the executable code may be prevented.

According to embodiments, because only a statically defined component is used in the process of generating a code, consistent outputs may be guaranteed in association with the same input. In this case, operation predictability of the AI agent may increase, and thus, the reliability of operation of the AI agent may be improved.

According to embodiments, various workflows may be implemented by utilizing the strong text generation ability of the large language model, and thus, an AI agent capable of flexibly coping with user requirements may be implemented.

According to embodiments, an error in a code generation process may be minimized through the process of verifying the pseudo-code for errors and regenerating the pseudo-code. Also, an execution speed may be improved through the generation of the static code, and resources may be optimally used.

According to embodiments, because functions of a system are expanded by adding a new step type or a tool to the schema, a general-purpose AI agent applicable to various application fields may be created (or developed).

Effects according to the present disclosure are not limited to the above effects, and effects not mentioned herein may be clearly understood from the specification and the accompanying drawings by one skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. An AI agent generation method using a large language model, which is performed by a processor, the method comprising:
receiving a request message from a user device;
generating a pseudo-code, which has a predefined schema and a predetermined data form, by using the large language model, in response to the request message thus received;
verifying the schema of the pseudo-code thus generated;
verifying validity of the pseudo-code thus generated;
generating an executable code based on the pseudo-code thus verified; and
executing the executable code, and
wherein the verifying of the schema of the pseudo-code thus generated includes:
determining whether a steps field or a dependencies field is included in the pseudo-code;
determining whether a first step field included in the steps field includes a compulsory field; and
determining whether a type of a type field included in the first step field is one of predefined types.

2. The method of claim 1, wherein the predetermined data form is a YAML (YAML Ain't Markup Language) form.

3. The method of claim 1, wherein the verifying of the validity of the pseudo-code thus generated includes:
determining whether a tool of a tool field included in the first step field is one of predefined tools; and
determining whether a cycle exists between step fields included in the steps field based on the dependencies field.

4. The method of claim 1, further comprising:
when the verifying of the schema or the verifying of the validity is failed, regenerating the pseudo-code,
wherein the regenerating of the pseudo-code is repeated up to N times (N being a positive integer).

5. The method of claim 1, wherein the generating of the executable code based on the pseudo-code thus verified includes:
mapping a step corresponding to at least one step field included in the pseudo-code in the form of a predetermined object, and
wherein the executable code is a static code.

6. The method of claim 1, further comprising:
transferring a result of executing the executable code to the user device.

7. A computing device for an operation of an AI agent, comprising:
a memory;
a transceiver configured to receive a request message from a user device; and
at least one processor including a large language model (LLM),
wherein the processor is configured to:
generate a pseudo-code, which has a predefined schema and a predetermined data form, by using the large language model, in response to the request message thus received,
verify the schema of the pseudo-code thus generated,
verify validity of the pseudo-code thus generated,
generate an executable code based on the pseudo-code thus verified, and
execute the executable code, and
wherein, in the verifying of the schema of the pseudo-code thus generated,
the processor is further configured to:
determine whether a steps field of a dependencies field is included in the pseudo-code;
determine whether a first step field included in the steps field includes a compulsory field; and
determine whether a type of a type field included in the first step field is one of predefined types.

8. A computer program stored in a computer-readable recording medium coupled to a computer being hardware and performing the AI agent generation method using the large language model of claim 1.

9. A non-transitory computer-readable recording medium having recorded thereon a computer program for executing an AI agent generation method, the method comprising:
receiving a request message from a user device;
generating a pseudo-code, which has a predefined schema and a predetermined data form, by using a large language model, in response to the request message thus received;
verifying the schema of the pseudo-code thus generated;
verifying validity of the pseudo-code thus generated;
generating an executable code based on the pseudo-code thus verified; and
executing the executable code, and
wherein the verifying of the schema of the pseudo-code thus generated includes:
determining whether a steps field or a dependencies field is included in the pseudo-code;
determining whether a first step field included in the steps field includes a compulsory field; and
determining whether a type of a type field included in the first step field is to one of predefined types.
